(19) United States
(12) Patent Application Publication
(10) Pub. No.: US 2008/0215485 A1
(43) Pub. Date: Sep. 4, 2008

(54) Automatic Reminder System for Check Ordering

(76) Inventor: Edward Tsang, Chatsworth, CA (US)

Correspondence Address: Robert A. Blaha;SMITH FROHWEIN TEMPEL, GREENLEE BLAHA LLC, Two Ravinia Drive, Suite 700, Atlanta, GA, 30346, US

(21) Appl. No.: 11/681,506

(22) Filed: Mar. 2, 2007

(51) Int. Cl. G06Q 40/00

(52) U.S. Cl. 705/40

(57) ABSTRACT

A method, apparatus, and computer readable storage to implement an automatic ordering system so that a bank customer can either receive automatic reminders or automatic reorder notification when it is time for the customer to reorder checks. The system tracks check numbers that the customer has in his or her possession and also tracks the check numbers that the customer has written. When the system determines that the customer is running low on checks, the customer can be presented with an automatic reminder to reorder, and then can easily reorder replacement checks. Alternatively, the system can automatically place the checks reorder for the customer if the automatic reorder option is enabled.

### BACKGROUND OF THE INVENTION

1. Field of the Invention

The present inventive concept is directed to a method, apparatus, and computer readable storage medium to implement an automatic reminder system to remind a user when it is time to reorder checks.

2. Description of the Related Art

A bank customer routinely receives a box of preprinted checks with the customer's personal information on it, such as his or her address, checking account number, etc.

Typically, when a customer uses up all of their preprinted checks, they can complete and mail a reorder slip that is provided with their preprinted checks to the bank to receive additional preprinted checks.

What is needed is an improved method for the customer to receive a reminder when it is time for the customer to reorder checks or optionally perform the reordering automatically.

### SUMMARY OF THE INVENTION

It is an aspect of the present inventive concept to provide an apparatus, method, and computer readable storage medium to facilitate automatic reminders for check reordering.

The above aspects can be obtained by a method that includes (a) providing a customer with at least one book of blank checks comprising a provided number of checks; (b) receiving a check written by a customer using the book of blank checks; (c) logging receipt of the check in a bank database; and (d) determining automatically if the customer is close to running out of blank checks, and if the customer is close to running out of blank checks, then depending on the customer preference settings to either provide an automatic reminder to the customer to order new checks or perform a check reordering for the customer automatically.

The above aspects can also be obtained by a system that includes (a) a check processing unit to process a received check written by a customer using the book of blank checks; (b) a bank database to log receipt of the check in the bank database; and (c) a determining unit to determine automatically if the customer is close to running out of blank checks, and if the customer is close to running out of blank checks, then a reminder unit provides an automatic reminder to the customer to order new checks or an ordering unit to perform reordering of checks for the customer automatically.

These together with other aspects and advantages, which will be subsequently apparent, reside in the details of construction and operation as more fully hereinafter described and claimed; reference to the accompanying drawings forming a part hereof, wherein like numerals refer to like parts throughout.

### BRIEF DESCRIPTION OF THE DRAWINGS

Further features and advantages of the present inventive concept, as well as the structure and operation of various embodiments of the present inventive concept, will become apparent and more readily appreciated from the following description of the illustrated embodiments, taken in conjunction with the accompanying drawings of which:

FIG. 1 is a flowchart illustrating an exemplary method to automatically detect when a customer is running out of checks, according to an embodiment;

FIG. 2A is a sample output screen indicating an automated pop-up reminder when a customer is almost out of checks, according to an embodiment;

FIG. 2B is a sample output screen illustrating a confirmation of check ordering, according to an embodiment;

FIG. 2C is a sample output screen indicated an email reminder when a customer is almost out of checks, according to an embodiment;

FIG. 2D is a sample message informing a customer that a check reorder has been placed when a customer is almost out of checks, according to an embodiment;

FIG. 3 is flowchart illustrating an exemplary method of processing an order for additional checks, according to an embodiment;

FIG. 4 is a block diagram illustrating components that interact as part of an automatic reminder system, according to an embodiment; and

FIG. 5 is a block diagram illustrating an alternative embodiment of a check reminder/reorder system.

### DETAILED DESCRIPTION

Reference will now be made in detail to the presently illustrated embodiments of the inventive concept, wherein like reference numerals refer to like elements throughout.

A customer can receive a box of checks from a bank, for example 300 checks. Each check has a check number on it. When the customer is almost out of checks (e.g., there are 50 left), the customer would benefit from either receiving an automatic reminder that it is time to reorder checks or automatic check reordering.

A bank database can track the check numbers that a customer has written. Thus, the bank knows how many (and which numbers) of checks that the customer has written. A bank database can track a number of checks that a customer has written, and when it reaches a predetermined amount, the customer can be automatically reminded that it is time to reorder checks. The automatic reminder can come in any form, such as a letter, a postcard, email, instant message, text message (via computer or cell phone), alert message during online banking, pop up screen during banking session at a branch, etc. The reminder can also allow the customer to reorder automatically checks by presenting an offer for new checks and receiving a confirmation by the customer to reorder (typically for a fee). Optionally, the system can be configured to perform reordering of checks for the customer automatically.

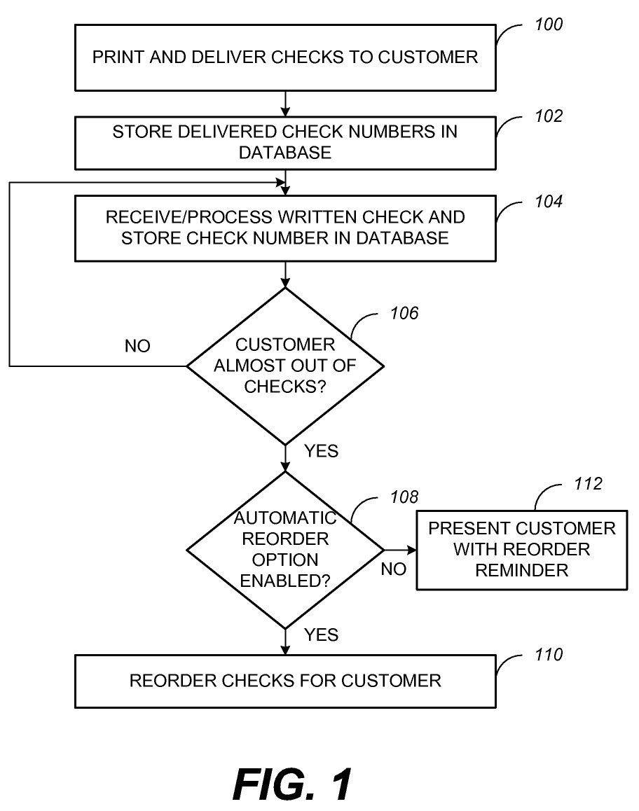

FIG. 1 is a flowchart illustrating an exemplary method to detect automatically when a customer is running out of checks, according to an embodiment.

The method can start with operation 100, wherein a bank (or a company affiliated with the bank) prints checks and delivers the checks to a customer of the bank. The checks can typically be placed in a box and mailed to the customer.

From operation 100, the method can proceed to operation 102, which stores the delivered check numbers in a database associated with the bank. For example, if the bank delivered checks numbered #001 to #200, these numbers would be stored in the bank database in a record or object associated with the customer. The database also knows how many checks the customer possesses.

From operation 102, the method proceeds to operation 104, wherein the customer writes a check. The issuing bank receives the written check when it is presented for payment. The issuing bank stores a check number associated with the written check in the database. Thus, the database contains each check number associated with checks written by the customer and a record or entry for each processed check written by the customer. Using the delivered check numbers and the record or entry for processed checks, the system can determine (exactly or approximately) how many checks the customer has remaining.

From operation 104, the method proceeds to operation 106, which determines whether the customer is almost out of checks. Since the database (in operation 102) knows how many checks (and/or which check numbers) the customer was given initially, and the database (in operation 104) also knows how many checks (and/or which check numbers) were written by the customer, the system can subtract the number of written checks from the number of checks the customer was initially given to determine the number of checks the customer has remaining. If this number is less than a predetermined amount (e.g., 30), then it can be determined that the customer is almost out of checks.

Alternatively, if the last check number written was a predetermined number (e.g., 170), then it can be determined that the customer is almost out of checks. This is because typically customers use check numbers in sequential order since this is how they appear in a checkbook. Thus, for example, if a customer is given check numbers #001 to #200, and the customer is up to check #170, then it can be concluded that the customer has 30 checks left. Thus, if the customer writes a check number which is equal to: (the last check number the customer was delivered minus a predetermined threshold of checks), then it can be determined that the customer is almost out of checks.

If the method does not determine that the customer is almost out of checks, then the method can return to operation 104, which can receive additional checks from the customer and store its respective number in a database.

If the determination in operation 106 determines that the customer is almost out of checks, then the method can proceed to operation 108, which determines whether the automatic reorder option is selected or otherwise stored in the customer preference database.

If the determination in operation 108 indicates that the automatic check reordering option is enabled, then the method can proceed to operation 110, which automatically reorders checks for the customer.

If the determination in operation 108 indicates that the automatic check reodering option is not enabled, then the method can proceed to operation 112, which automatically presents the customer with a reorder reminder. For example, the customer can be sent an email message reminding the customer that it is time to reorder checks. The customer can also receive a text message (via personal computer or cell phone), an automated (or human) phone call reminder, etc.

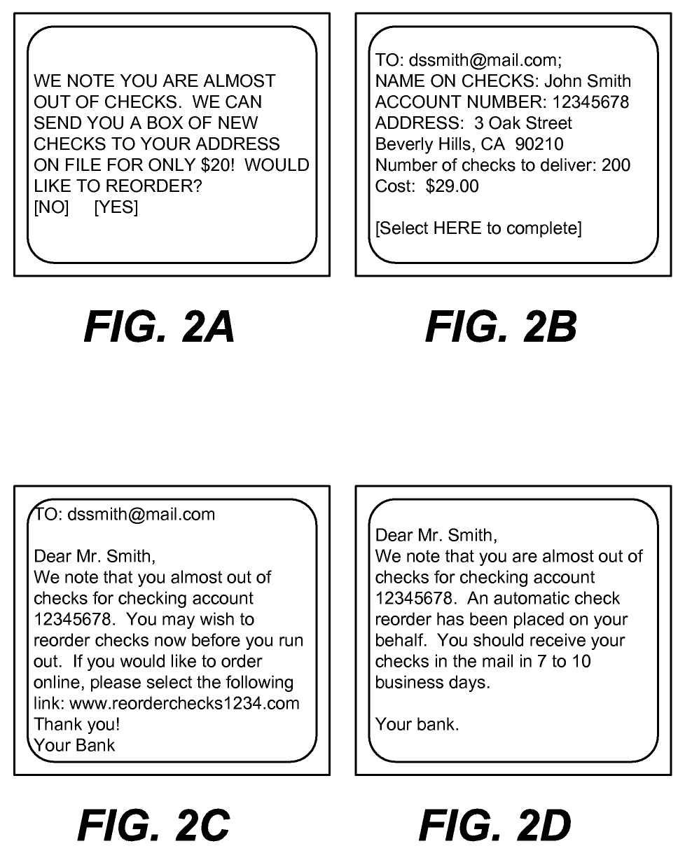

FIG. 2A is a sample output screen indicating an automated pop-up reminder when a customer is almost out of checks, according to an embodiment.

A reminder can pop up on the customer's computer screen (or cell phone, etc.), such as illustrated in FIG. 2A. The customer may be able to select directly on the pop up screen that he or she wishes to reorder checks, upon which a new screen can appear such as that illustrated in FIG. 2B.

FIG. 2B is a sample output screen illustrating a confirmation of check ordering, according to an embodiment. The system can automatically retrieve the fields from the database (e.g., customer name, address, account number, etc.), so the customer can simply select and order new checks without much effort.

FIG. 2C is a sample output screen illustrating an email reminder when a customer is almost out of checks, according to an embodiment.

As an alternative to a pop up window, the customer can receive an email message with a reminder that the customer needs to reorder checks. The email message may contain a link that the user can select, which can automatically produce a confirmation screen such as that illustrated in FIG. 2B.

When the user is presented with a reminder, the user can then receive an automatic confirmation screen (such as that illustrated in FIG. 2B) which already contains customer specific information, thus making it easy for the customer to reorder checks. The automated reminder and processing of such an order can be accomplished automatically with little effort by the customer.

FIG. 2D is a sample of an automatic check reordering notification message to the customer after a reorder has been placed. The system can automatically retrieve the latest check information (e.g. customer name, address, account number, etc.) from the bank database to complete the reordering.

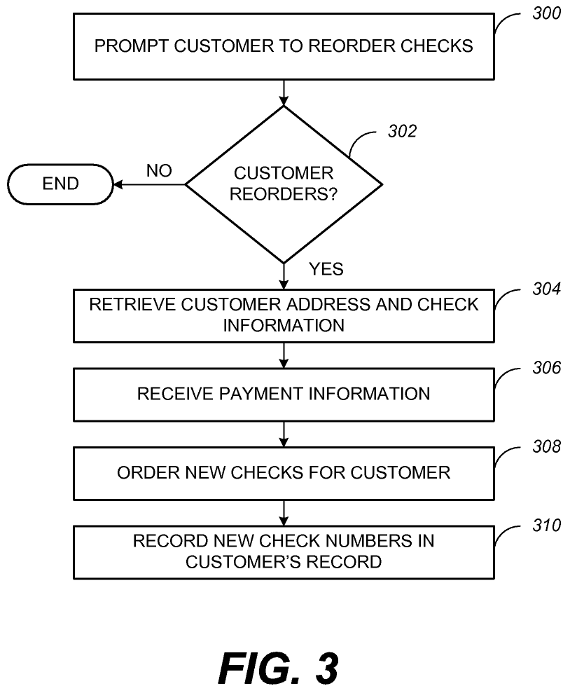

FIG. 3 is flowchart illustrating an exemplary method of processing an order for additional checks not using the automatic reorder feature, according to an embodiment.

In operation 300, the method prompts the customer whether he or she wishes to reorder checks. This can be done as illustrated in FIG. 2A.

From operation 300, the method can proceed to operation 302, which determines whether the customer reorders. The customer can reorder by simply selecting or engaging an appropriate input control on his computer, cell phone, telephone, etc.

If the customer reorders, then the method can proceed to operation 304, which retrieves the customers address and check information (account number and other related information), plus any other additional information that is needed to reorder checks. All of this information can be displayed to the customer, for example as illustrated in FIG. 2B.

From operation 304, the method can proceed to operation 306, which can receive payment information from the customer. This can be done as known in the art, such as allowing the customer to input credit card information, debit funds from a designated account, etc.

From operation 306, the method can proceed to operation 308, which orders new checks for the customer. The system can place an order electronically with the bank's fulfillment system using the information retrieved in operations 304 and 306 (plus any additional information entered by the customer).

From operation 308, the method can proceed to operation 310, which records the new check numbers (the checks that were ordered in operation 308 and that will be delivered to the customer) in a database so that either a new reminder or an automatic checks reorder (using the methods described herein) can be sent to the customer when this batch of checks is almost used up as well.

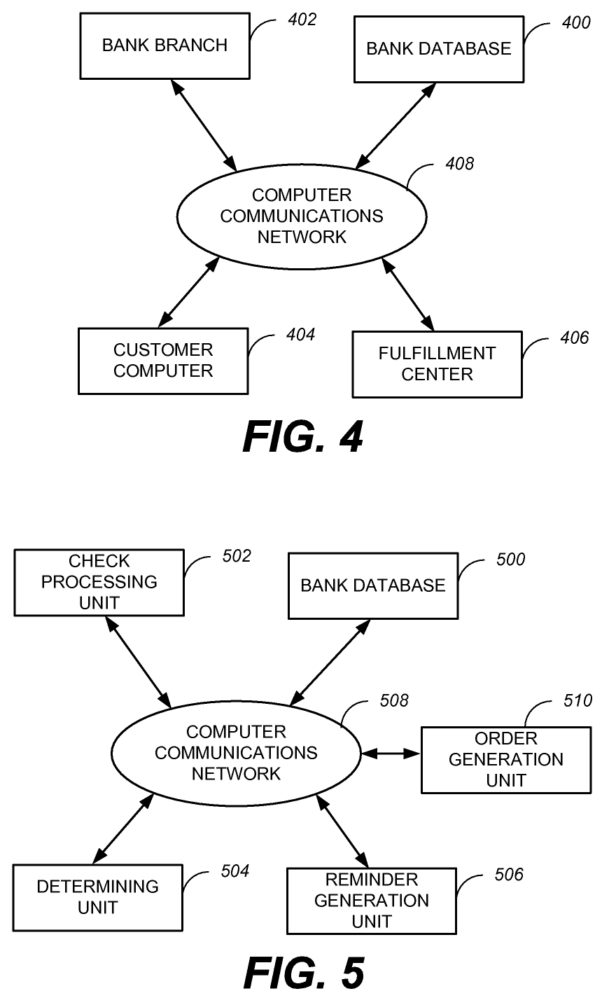

FIG. 4 is a block diagram illustrating components that interact as part of an automatic reminder system, according to an embodiment.

A bank database 400 can store all records relating to a bank's customers, including their account information (name, addresses, checks written, checks not written, money in account(s), etc.) and preferences for automatic checks reorder. A bank branch 402 can process checks written by the customer and transmit information about the checks (e.g., check numbers, check images) to the bank database 400 for entry into the customer's account. A customer's computer 404 is a remote client used by the customer to access the customer's accounts stored in the bank database 400 using a computer communications network 408 such as the Internet and a web browser. A fulfillment center 406 is used when the customer reorders checks (on the customer's own initiative, in response to an automated reminder, or automatic checks reorder). The fulfillment center 406 can package ordered checks and ship them (for example via the mail) to the customer. The fulfillment center 406 can also transmit numbers of the checks delivered to the bank database 400 so that the bank database 400 can record the check numbers that the customer has in the customer's record so that either a timely reminder or automatic checks reorder can be presented to the customer when the customer is running low on checks.

FIG. 5 is a block diagram illustrating an alternative embodiment of an automatic reminder/reorder system.

A bank database 500 can store all records relating to a bank's customers, including their account information (name, addresses, checks written, checks not written, money in account(s), etc.) and preferences for automatic checks reorder. A check processing unit 502 identifies which checks written by the customer have been presented to the bank for payment. The check processing unit 502 not only identifies the check by number but transmits information about the checks (e.g., presenting bank, date presented, amount, check images) to the bank database 500 for entry into the customer's account. A determining unit 504 accesses the customer's accounts stored in the bank database 500 using a computer communications network 508 such as the Internet or a private data network. The determining unit 504 uses information stored in the bank database 500 to determine if a customer reminder to order checks should be initiated or if a order should be initiated. When one or more parameters stored in the bank database 500 indicate that a reminder should be initiated, determining unit 504 forwards a signal via computer communications network 508 to reminder generation unit 506. Accordingly, reminder generation unit 506 constructs the appropriate message or messages to be communicated to the customer. Communication mechanisms include email, a prompt at an automated teller, a prompt to a teller terminal, a mailed letter, a call, among others. When one or more parameters stored in bank database 500 indicate that an automatic order should be generated, order generation unit 510 initiates a communication to a check printer to complete and deliver the customer's order.

Thus, an example of the methods will now be presented. Joe opens a new account and receives a book of checks with numbers 1 to 100. The check numbers 1 to 100 are stored in the bank database in a record associated with Joe. Joe writes check #1. After the check has been presented for payment and processed by the bank, the number 1 is stored in Joe's account. A counter can also be incremented each time Joe writes a check and the check is processed by the bank. The counter can be stored in the bank database. Joe writes 60 more checks, which are all processed and stored accordingly in the bank database. Each time the system processes a check written by Joe, it can determine whether Joe is running low on checks. In an embodiment, the system can use a simple counter, and since it knows Joe originally had 100 checks and has written 61, the system can determine via a mathematical process that Joe has 39 checks left. The system can give an automatic reminder when a customer has less than 40 checks left. Thus, Joe can receive an automatic reminder after writing the 61^{st} check. This is similar to taking the total number of checks Joe was initially provided with (100) and subtracting a number of checks Joe has written (39).

Alternatively, the system can give Joe an automatic reminder when Joe writes check #61. If Joe writes checks out of order, this may trigger a reminder even though Joe hasn't written 61 checks yet.

In still another embodiment, the system can be configured to initialize a counter to the number of checks that were initially provided to Joe. Each time a check is processed by the bank, the bank can decrement the counter and compare the counter value with a threshold value. The threshold value can be preconfigured or user configurable. When the counter value is equal to or less than the threshold value, Joe is low on checks.

When the customer's preference is set to automatic check reordering, a reorder will be placed automatically without further customer authorization when the system determines that Joe or another customer is running low on checks.

It is noted that any of the operations described herein can be performed in any sensible order. Further, some operations may be optional. Also, any feature or embodiment described herein can be combined with any other. Any method described herein also includes hardware needed to implement the method, and also any software that can be stored on a computer readable storage medium which can instruct the hardware to perform the method.

The many features and advantages of the inventive concept are apparent from the detailed specification and, thus, it is intended by the appended claims to cover all such features and advantages of the inventive concept that fall within the true spirit and scope of the inventive concept. Further, since numerous modifications and changes will readily occur to those skilled in the art, it is not desired to limit the inventive concept to the exact construction and operation illustrated and described, and accordingly all suitable modifications and equivalents may be resorted to, falling within the scope of the inventive concept.

What is claimed is:

1. A computer implemented method to automatically remind a customer to reorder checks, the method comprising:
providing a customer with at least one book of blank checks comprising a provided number of checks;
receiving a check written by a customer using the book of blank checks;
logging receipt of the check in a bank database; and
determining automatically if the customer is close to running out of blank checks, and if the customer is close to running out of blank checks, then providing an automatic reminder to the customer to order new checks.

2. The method as recited in claim 1, wherein the determining identifies that the customer is close to running out of blank checks when a check number of the check written by the customer matches a predetermined number.

3. The method as recited in claim 2, wherein the predetermined number is retrieved from a bank database which stores check numbers for the at least one book of blank checks provided to the customer.

4. The method as recited in claim 1, wherein the determining identifies that the customer is close to running out of blank checks when a check number of the check written by the customer is greater than a predetermined number.

5. The method as recited in claim 4, wherein the predetermined number is retrieved from a bank database which stores check numbers for the at least one book of blank checks provided to the customer.

6. The method as recited in claim 1, wherein the determining identifies that the customer is close to running out of blank checks when the provided number of checks minus a total number of checks written by the customer out of the at least one book of checks equals a predetermined number.

7. The method as recited in claim 1, wherein the determining identifies that the customer is close to running out of blank checks when the provided number of checks minus a total number of checks written by the customer out of the at least one book of checks is less than a predetermined number.

8. The method as recited in claim 1, wherein the determining identifies that the customer is close to running out of blank checks by incrementing a counter whenever a check is received by the bank, and comparing the counter to a predetermined reminder number stored for the customer based on the provided number of checks.

9. The method as recited in claim 1, wherein the determining identifies that the customer is close to running out of blank checks by decrementing a counter whenever a check is received by the bank, and comparing the counter to a predetermined number stored for the customer.

10. The method as recited in claim 1, wherein when the providing the automatic reminder also comprises offering the customer a chance to automatically order replacement checks.

11. The method as recited in claim 10, wherein the customer orders replacement checks without having to type in the customer's name and account number.

12. The method as recited in claim 10, wherein if the customer orders replacement checks, then replacement blank checks are mailed to the customer, and replacement check numbers corresponding to the replacement blank checks are transmitted to the bank database.

13. A computer implemented method to automatically order customer checks, the method comprising:
providing a customer with at least one book of blank checks comprising a provided number of checks;
receiving a check written by a customer using the book of blank checks;
logging receipt of the check in a bank database; and
determining if the customer is close to running out of blank checks, and if the customer is close to running out of blank checks and an automatic reorder option is enabled, then initiating an order for new checks for the customer.

14. The method as recited in claim 13, wherein the determining identifies that the customer is close to running out of blank checks when a check number of the check written by the customer matches a predetermined number.

15. The method as recited in claim 14, wherein the predetermined number is retrieved from a bank database which stores check numbers for the at least one book of blank checks provided to the customer.

16. The method as recited in claim 13, wherein the determining identifies that the customer is close to running out of blank checks when a check number of the check written by the customer is greater than a predetermined number.

17. The method as recited in claim 16, wherein the predetermined number is retrieved from a bank database which stores check numbers for the at least one book of blank checks provided to the customer.

18. The method as recited in claim 13, wherein the determining identifies that the customer is close to running out of blank checks when the provided number of checks minus a total number of checks written by the customer out of the at least one book of checks equals a predetermined number.

19. The method as recited in claim 13, wherein the determining identifies that the customer is close to running out of blank checks when the provided number of checks minus a total number of checks written by the customer out of the at least one book of checks is less than a predetermined number.

20. The method as recited in claim 13, wherein the determining identifies that the customer is close to running out of blank checks by incrementing a counter whenever a check is received by the bank, and comparing the counter to a predetermined number stored for the customer based on the provided number of checks.

21. The method as recited in claim 13, wherein the determining identifies that the customer is close to running out of blank checks by decrementing a counter whenever a check is received by the bank, and comparing the counter to a predetermined number stored for the customer.

22. A system to automatically remind a customer to reorder checks after the customer has received at least one book of blank checks comprising a provided number of checks, the system comprising:
a check processing unit to process a received check written by a customer using the book of blank checks;
a bank database to log receipt of the check in the bank database; and
a determining unit to determine automatically if the customer is close to running out of blank checks, and if the customer is close to running out of blank checks, then a reminder unit provides an automatic reminder to the customer to order new checks.

23. A system to automatically order checks for a checking account customer, the system comprising:
a check processing unit configured to process a received check written by a customer;
a bank database configured to log receipt of the check in the bank database; and
a determining unit configured to determine if the customer is close to running out of blank checks, and if the customer is close to running out of blank checks, then ordering new checks for the customer.
